(19) United States
(12) Patent Application Publication
(10) Pub. No.: US 2006/0001185 A1
(43) Pub. Date: Jan. 5, 2006

(54) Molding method and molding apparatus

(75) Inventors: Hiroshi Miyakoshi, Tokyo (JP); Kazumi Furuta, Tokyo (JP); Masahiro Morikawa, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: KONICA MINOLTA HOLDINGS, INC., Tokyo (JP)

(21) Appl. No.: 11/159,600

(22) Filed: Jun. 23, 2005

(30) Foreign Application Priority Data
Jun. 30, 2004 (JP) JP2004-193447

(51) Int. Cl. B29D 11/00

(52) U.S. Cl. 264/1.32; 425/144

(57) ABSTRACT

A molding method which is a method for molding an element having a microscopic structure, and by which the raw material whose elastic modulus in the normal temperature is 1-4 (GPa) is attached to the holding unit, the temperature of the mold having the microscopic structure is increased higher than the glass transition temperature of the raw material, the mold is pressed toward the raw material and the microscopic structure is transferred onto the raw material, and the mold is released from the raw material under the condition that the raw material is heated.

### BACKGROUND OF THE INVENTION

1. Field of the Invention

The present invention relates to a molding method and a molding apparatus, particularly to a molding method and a molding apparatus, adequate for molding an optical element having a microscopic structure of high aspect ratio.

2. Description of the Related Art

Recently, in the field of an optical pick-up apparatus, which is developing quickly, an optical element such as an extremely high accurate objective lens is used. When a raw material such as plastic or glass is molded to such an optical element by using a metallic mold, a uniform shaped product can be manufactured quickly. That is, it can be said that such a metallic-mold molding is appropriate for a mass-production of the optical elements for such an application.

Further, as a recent optical pick-up apparatus, by using a light flux from a shorter wavelength semiconductor laser, an apparatus by which the recording and/or reproducing of the high density information can be conducted on a recording medium such as HD DVD (High Definition DVD), BD (Blue-ray Disc), is developed. For the improvement of the aberration characteristic of the optical system, it is conducted that a diffractive structure, which is a microscopic structure, is provided on the optical surface. Further, even in the optical pick-up apparatus by which the recording and/or reproducing of the such high density information can be conducted, it is necessary that the recording and/or reproducing of the information is secured also for the conventionally enormously supplied CD, DVD. For that, it is also conducted that the diffractive structure with the wavelength selectivity is provided. Further, in the optical pick-up apparatus by which the recording and/or reproducing of the information is compatibly conducted for DVD and CD, for the purpose that the optical system is communized, a wavelength plate for giving the phase difference is used, and the wavelength plate having the microscopic structure is also developed.

Herein, the diffractive structure is, although depending on the used light source wavelength, for example, a ring-shape zone structure whose step difference is about 2 μm at minimum, further, because the above-described type wavelength plate has a line and space structure arranged at pitch lower than ½ of the wavelength of the transmitting light, in the normal injection molding, only by injecting the melted resin into the mold, the raw material is hardly entered deep in the depth of the step difference of the microscopic structure formed in the mold. Therefore, there is a problem that the transfer of the microscopic structure is not accurately conducted. When the microscopic structure as designed is not formed due to transfer fault (sagging of the raw material), the optical characteristic is deteriorated. As that result, there is a possibility that the writing error is generated in the optical pick-up apparatus using such an optical element. Therefore, numerous countermeasures are taken in such a manner that the raw material is selected, or the temperature or pressure of melted resin is adjusted, however, by the conventional method, it is difficult that sagging is perfectly eliminated.

On the one hand, in Tokkai No. 2002-220241, a method for molding an optical element having the microscopic pattern on the surface, when glass material under the heated and soften condition is pressed, is disclosed.

However, by the technology written in the above patent publication, it is a limit that the microscopic structure of the aspect ratio of about 0.2 in which the width is 100-50 μm, height is about 20-10 μm is molded on the surface of glass material. By means of this technology, because the elastic modulus of the inorganic glass in the normal temperature is about 70 GPa and high, even when the heated mold is pressed onto its surface by the vary large force of 3000 N, the glass material is not smoothly flowed into the depth of the microscopic structure. As the result, only the microscopic structure whose aspect ratio is about 0.2 can be molded. Accordingly, the moldings having the microscopic structure whose aspect ration is, for example, not smaller than 1, may exist as a prototype, however, it does not exist yet as an industrial product whose shape is uniform.

Further, the present inventors also find a problem that, after heated mold is pressed to the raw material and the material is molded, when the mold is released, the microscopic structure of the transferred material is not separated from the microscopic structure of the mold, and a part of the microscopic structure of the raw material is torn.

### SUMMARY OF THE INVENTION

An object of the present invention is to solve the problems of the conventional technology.

Further object of the present invention is to provide a molding method and a molding apparatus by which moldings having the microscopic structure of high aspect ratio can be molded more simply and in low cost.

Yet further object of the present invention is to provide a molding method and a molding apparatus by which, when the moldings are released from the molding die, the microscopic structure of the transferred material is not torn.

These and other objects are attained by a molding method having the steps of attaching a raw material whose elastic modulus is 1-4 (GPa) to a holding unit; setting a temperature of a mold having a microscopic structure to a temperature higher than a glass transition point temperature of the raw material; and pressing the mold toward the raw material so as to transfer the microscopic structure onto the raw material.

Further, the above object of the present invention is attained by a molding method having the steps of attaching a raw material to a holding unit; setting a temperature of a mold having a microscopic structure to a temperature higher than a glass transition point temperature of the raw material; pressing the mold toward the raw material so as to transfer the microscopic structure onto the raw material; and releasing the mold from the raw material under a condition that the raw material is heated.

Furthermore, the above object of the present invention is attained by the molding method having the steps of attaching a raw material to a holding unit; setting a temperature of a mold having a microscopic structure to a temperature higher than a glass transition point temperature of the raw material; pressing the mold toward the raw material so as to transfer the microscopic structure onto the raw material; and releasing the mold from the raw material while a tensile stress is being given to the raw material.

The invention itself, together with further objects and attendant advantages, will best be understood by reference to the following detailed description taken in conjunction with the accompanying drawings.

### BRIEF DESCRIPTION OF THE DRAWINGS

FIGS. 1(a) and 1(b) are views for explaining an aspect ratio;

FIGS. 2(a) and 2(b) are sectional views of a molding apparatus of an optical element by which a molding method according to the first example can be conducted;

FIG. 3 is a flowchart showing the molding method according to the first example;

FIG. 4 is a view showing a control profile of each of parameters in the molding method;

FIGS. 5(a), 5(b) and 5(c) are sectional views of the molding apparatus of the optical element by which the molding method according to the second example can be conducted;

FIG. 6 is a flowchart showing the molding method according to the second example;

FIG. 7 is a block diagram including a control unit; and

FIG. 8 is a perspective view showing an element having the molded microscopic patterns.

In the following description, like parts are designated by like reference numerals throughout the several drawings.

### DESCRIPTION OF THE PREFERRED EMBODIEMENT

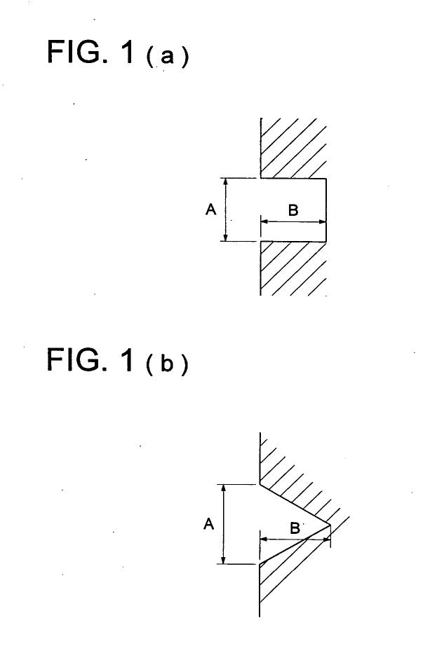

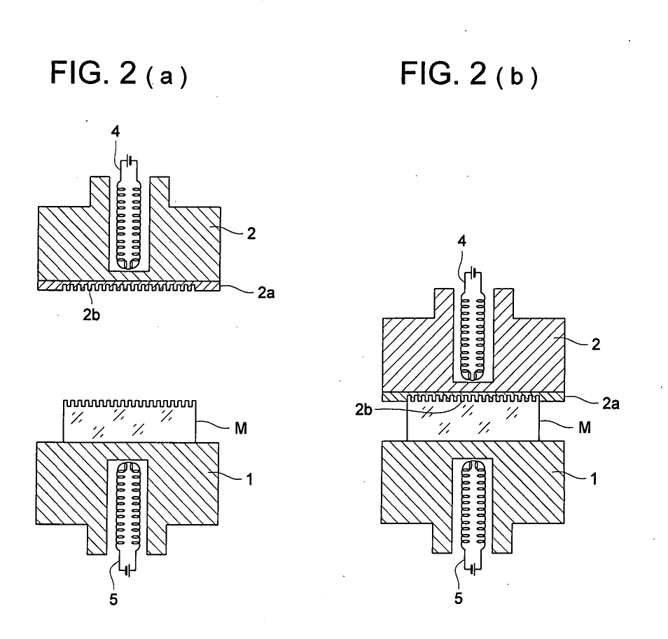

Referring to the drawings, examples will be described below. FIG. 1 are views for explaining an aspect ratio. The aspect ratio is, as shown in FIGS. 1(a), (b), when the width of concave part or convex part is A, the depth or height is B, referred to a value expressed as B/A. FIG. 2 is a sectional view of a molding apparatus of an optical element by which a molding method according to the first example can be carried out. In FIG. 2, above the lower mold 1 fixed to a frame, not shown, formed of SUS 304, the upper mold 2 formed of SUS 304 is relatively movably arranged. The lower mold 1 as a holding unit fixes a raw material M (it is preferable when its elastic modulus at a normal temperature is 1-4 (Gpa)) to the upper surface.

To the lower surface of the upper mold 2, a mold disc 2a of silicon is fixed, and on the lower surface, for example, in order to use for a wavelength plate, the microscopic structure 2b whose aspect ratio is not smaller than 1 is formed by an electron beam drawing. In the first example, it is presumed that, on the raw material of PMMA (molecular weight is 70 thousands, glass transition point temperature Tg is 100° C., longitudinal elastic modulus is 3.3 GPa), a microscopic structure of line and space whose pattern area is 1 mm×1 mm, height is 350 nm, width is 200 nm, and pitch is 200 nm, is transferred and formed.

Inside of the upper mold 2, the first heater 4 is arranged. On the one hand, inside of the lower mold 1, the second heater 5 is arranged. The mold is structured by the upper mold 2 and the mold disc 2a. Hereupon, although not shown, a drive unit for relatively moving the upper mold 2 to the lower mold 1 in the approaching and separating direction, is provided.

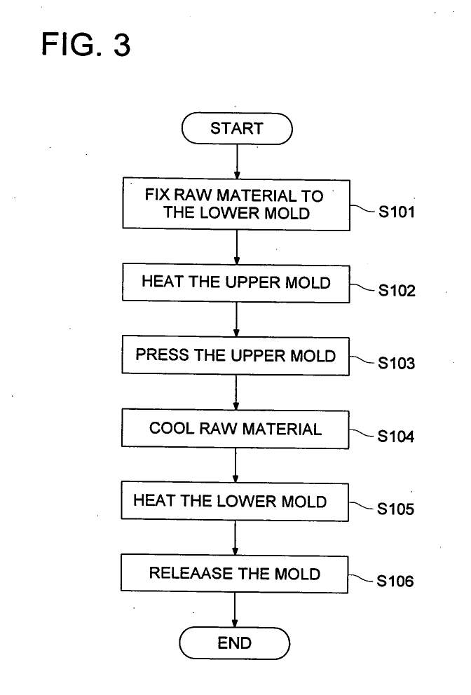

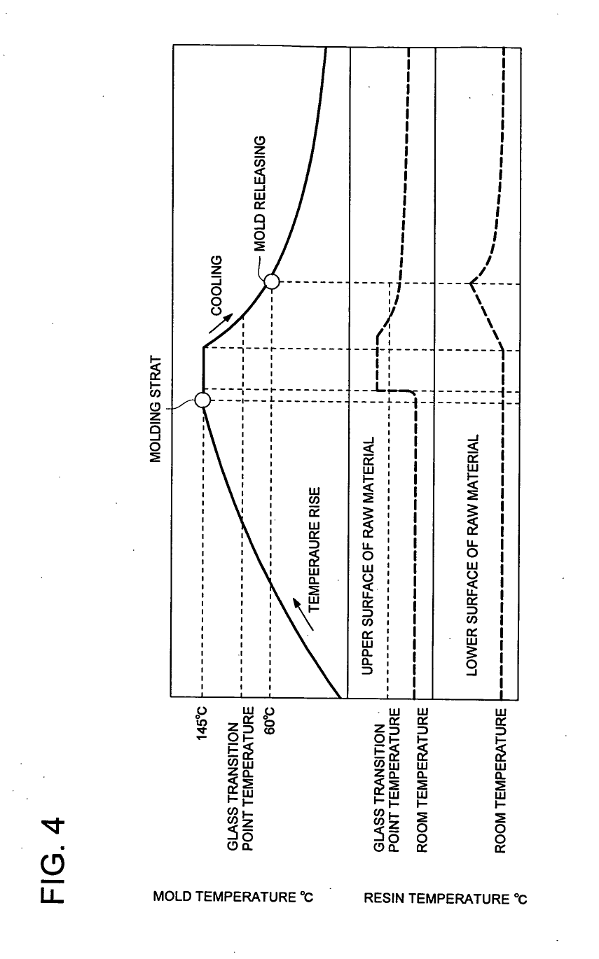

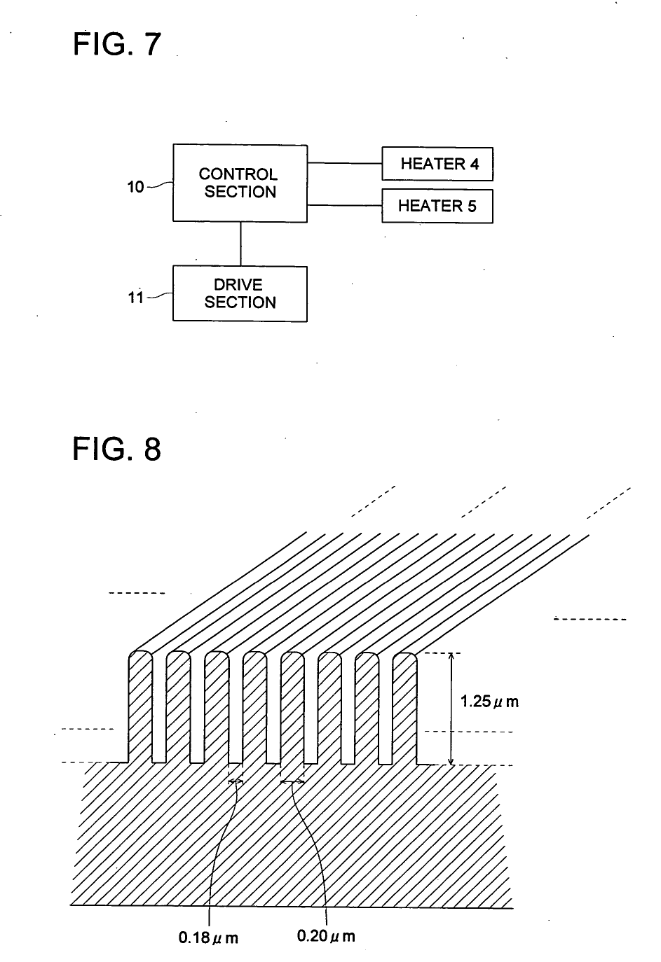

FIG. 7 is a block diagram showing the relationship of a control unit 10 controlling a heater 4, heater 5 and the driving unit 11. The control unit 10 carries out the control shown in the following flowchart. FIG. 3 is a flowchart showing a molding method according to the first example. FIG. 4 is a view showing the control profile of each parameter in the molding method according to the first example. Referring to the drawings, such a molding method will be described. Initially, in step S101, as shown in FIG. 2(a), on the upper surface of the lower mold 1, a raw material M is fixed (step for attaching the raw material to a holding unit). Furthermore, in step S102, the heater 4 is heated, and the upper mold 2 is heated higher than the glass transition point Tg (step for setting the temperature of the mold to a temperature higher than the glass transition point of the raw material).

Further, at a stage (time t1 in FIG. 4) at which the lower surface of the mold disc 2a is heated higher than the glass transition point Tg, as shown in FIG. 2(b), the driving unit, not shown, is driven, and the raw material M is pressed by the upper mold 2 (step S103). Then, the upper surface of the raw material M is quickly heated higher than the glass transition point Tg and melted, (time t1 in FIG. 4), and the microscopic structure 2b of the mold disc 2a is transferred onto its surface (step for pressing the mold to the raw material and transferring the microscopic structure onto the raw material).

Successively, in step S104, the heating of the first heater 4 is stopped, the upper mold 2 is naturally cooled (may be forcibly cooled), thereby, the upper surface temperature of the raw material M is lowered so that it is lower than the glass transition point Tg.

Before and after this (herein, at time t3 in FIG. 4), in step S105, the second heater 5 is heated, and the lower mold 2 is heated. When the lower mold 2 is heated, the rear surface of the raw material in close contact to it is also heated. Hereupon, when the thermal expansion coefficient of the mold disc 2a is α2a, and the thermal expansion coefficient of the raw material M is αM, and under the condition that the temperature of the mold disc 2a is lowered by ΔT2a, the mold release is carried out, in order to avoid the dislocation due to the thermal expansion difference between the mold disc 2a and the raw material, the temperature of the rear surface of the raw material M may be risen by ΔT=(1−α2a/αM) ΔT2a. However, when the elasticity of the raw material is also considered, it is not necessary to exactly control to this temperature.

Further, at time t4 in FIG. 4, in step S106, the upper mold 2 is released from the raw material M (step for releasing the mold from the raw material under the condition that the rear surface of the raw material is heated).

According to the first example, even when the thermal expansion coefficient of the raw material M is larger than the thermal expansion coefficient of the mold, when the mold releasing is carried out under the condition that the rear surface of the raw material M is heated, because the contraction of the raw material M side is suppressed, the tearing of the microscopic structure at the time of the mold releasing, can be suppressed.

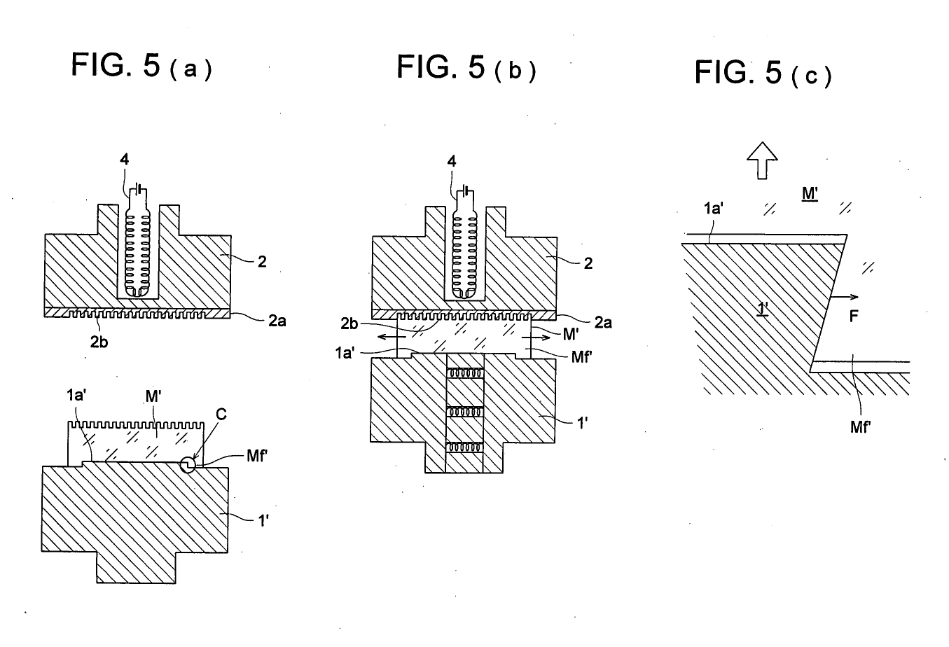

FIGS. 5(a), (b) are sectional views of the molding apparatus of the optical element by which the molding method according to the second example can be carried out. FIG. 5(c) is a view enlargedly showing an arrowed C-part of FIG. 5(a) at the time of mold releasing. In the second example, from the above first example, because only the structure of the raw material M′ and the low mold 1′ is different, like signs are given to like structures and the description will be omitted.

In the second example, on the lower mold 1′ as the holding unit, the heater is not provided, and on its upper surface, a cylindrical part 1a′ is formed. On the one hand, on the outer periphery of the rear surface of the raw material M′, a flange Mf′ is formed. The inner peripheral surface of the flange Mf′ is, as shown in FIG. 5(c), an inverse taper shape, that is, a shape whose diameter is enlarged as advancing toward the bottom part (upper side in FIG. 5). Such an inverse taper shape can be formed by machining after the inner peripheral surface of the flange Mf′ is molded cylindrically, or can be directly formed by using a moving mold which moves in the direction crossing with the drawing direction after the molding. On the one hand, the outer peripheral surface of the cylindrical part 1a′ is formed into the inverse taper shape corresponding to the inner peripheral surface of the flange Mf′. In the normal temperature, the inner diameter of the end part of the flange Mf′ is smaller than the outer diameter of the end part of the cylindrical part 1a′ (refer to FIG. 5(c)). The cylindrical part 1a′ structures a stress means.

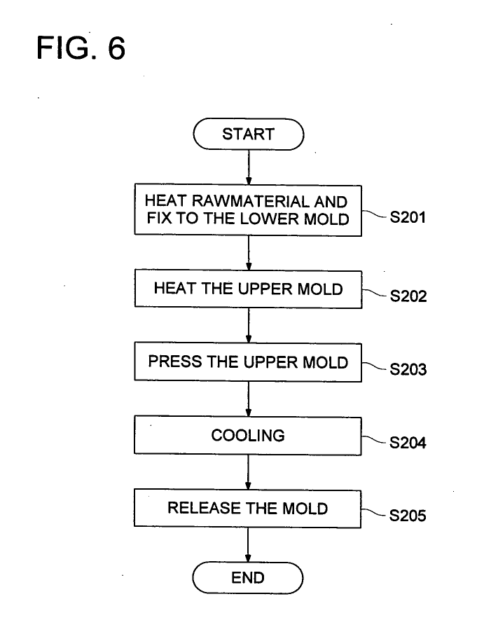

FIG. 6 is a flowchart showing a molding method according to the second example. Referring to FIG. 6, such a molding method will be described. Initially, in step S201, when the raw material M is heated not so as to exceed the glass transition point (or the lower mold 1′ may be cooled), because the inner diameter of the end part of the flange Mf′ is larger than the outer diameter of the end part of the cylindrical part 1a′ due to the thermal expansion, the raw material M is fixed to the lower mold 1 in such a manner that the flange Mf′ is engaged with the cylindrical part 1a′, as shown in FIG. 5(a), (a step for attaching the raw material to the holding unit). When the temperature of raw material M′ is lowered, the raw material M′ is contracted and engaged with the cylindrical part 1a′ and fixed.

Further, in step S202, the heater 4 is made heated and the upper mold 2 is heated to a temperature not lower than the glass transition point temperature Tg (a step to set a temperature of the mold to a temperature higher than the glass transition point temperature of the raw material).

In the step in which the lower surface of the mold disc 2a is heated higher than the glass transition point temperature Tg, as shown in FIG. 5(b), the upper mold 2 presses the raw material M′ by driving the drive unit, not shown, (step S203). Then, the upper surface of the raw material M′ is quickly heated higher than the glass transition point temperature and melted, and the microscopic structure 2b of the mold disc 2a is transferred onto its surface (a step in which the mold is pressed to the raw material, and the microscopic structure is transferred onto the raw material).

Successively, in step S204, the heating of the first heater 4 is stopped, and the upper mold 2 is naturally cooled, (forced cooling may also be allowable), thereby, the upper surface temperature of the raw material M′ is lowered lower than the glass transition point temperature Tg.

In this case, because the inner diameter of the end part of the flange Mf′ is smaller than the outer diameter of the end part of the cylindrical part 1a′, under such a condition, in step S205, when the upper mold 2 is released in such a manner that it is separated from the raw material M, and accompanied with that, because the raw material M′ also receives a force by which it is separated from the lower mold 1′, the flange Mf′ receives an outward force F in the radial direction (a step by which, while giving the tensile stress to the raw material, the mold is released from the raw material). In this case, when the joining force of the upper mold 2 and the raw material M′ is lower than the joining force of the raw material M′ and the lower mold 1′, the upper mold 2 can be released from the raw material M′.

According to the second example, by using the force at the time of mold releasing, because, when the outward force F in the radial direction is applied on the flange Mf′, the contraction on the raw material M′ side can be suppressed, the tearing of the microscopic structure at the time of mold releasing can be suppressed. Hereupon, the separation of the raw material M′ and the lower mold 1′ can be easily carried out by the heating of the raw material M′ or the cooling of the lower mold 1′.

Hereupon, as the stress means, other than this, an active means for giving a mechanical tensile stress to the raw material by driving a part of the cylindrical part 1a′ to the outward in the radial direction by an air cylinder, can also be used.

FIG. 8 is a view showing a molded element by the molding method and apparatus shown in the above example. This element has the microscopic structure of line and space in which walls whose height is 1.25 μm, and width is 0.20 μm, are arranged in a space of 0.18 μm. Hereupon, as the microscopic structure, other than the line and space, various microscopic structures such as a shape in which concentric circular grooves are formed, can be considered.

As described above, in the case of resin material whose elastic modulus at the normal temperature is 1-4 (Gpa), when the mold having the microscopic structure is heated and pressed to its surface, the pressed surface is melted and follows the microscopic structure, and as the result, even when, for example, the aspect ratio is larger than 1, the moldings onto which the microscopic structure of the mold is accurately transferred, can be obtained. Then, in this case, it is also not necessary that the mold is pressed by a large pressure worthy of 3000 N. Further, it can be carried out only by improving the conventional injection molding machine, and the cost of the manufacturing facility is reduced, further, a large amount of moldings can be manufactured in a short period of time.

Hereupon, as the raw material whose elastic modulus at the normal temperature is 1-4 (GPa), it is preferable that resin of the range in which the elastic modulus is 1-4, such as, for example, PMMA (elastic modulus is 1.5-3.3 GPa), polycarbonate (elastic modulus is 3.1 GPa), poly olefin (elastic modulus is 2.5-3.1 GPa), is included as the composition component.

Herein, the normal temperature means 25° C. It is preferable that, in these resins, whose glass transition points are 50-160° C. The elastic modulus can be found according to JIS-K7161, 7162 or the like. The glass transition point temperature can be found according to JIS R3102-3: 2001.

The present inventors considered that, for the cause that the microscopic structure of the transferred raw material is tone when the mold is released, at the time of cooling of the heated mold and raw material, because the contraction amount is different corresponding to the difference of thermal expansion of them, the internal stress in which the microscopic structures on the raw material side strongly nip the microscopic structure of the mold, is generated in the raw material. Accordingly, as the result of the study, the present inventors introduces that, when, after the microscopic structure is transferred onto the raw material, the raw material is heated, and the mold releasing is carried out under the condition that the temperature of the raw material is higher than the room temperature, because the contraction on the raw material side is suppressed, the tearing of the microscopic structure at the time of the mold releasing can be suppressed. Hereupon, when the raw material is heated, the vicinity of the rear surface of the raw material may be heated. Hereupon, “the rear surface of the raw material” is the surface opposite to the surface onto which the microscopic structure is transferred.

Further, as described above, the present inventors found that, because the contraction on the raw material side is suppressed when, after the microscopic structure is transferred onto the raw material, the mold is released while the tensile stress being given to the raw material, the tearing of the microscopic structure at the time of mold releasing can be suppressed.

It is preferable that the raw material is a raw material of the optical element, and it can also be applied to a head of the inkjet printer.

Further, it is preferable when the microscopic structure has an aspect ratio higher than 1, and includes a plurality of line-and-spaces which are arranged in a predetermined pitch.

“The microscopic structure” is the shape in which a value of A is not larger than 10 μm. The thickness of the raw material is preferably 0.1-20 mm, more preferably 1-5 mm. Hereupon, it is of course that the first example and the second example may be used together.

In the above, the present invention is described referring to examples, however, the present invention should not be construed being limited to the above examples, and it is of course that the present invention can be appropriately changed and improved. The present invention is not limited to the optical element for the optical pick-up apparatus, but can also be applied to various optical elements or heads of the inkjet printers.

According to the present example, the molding method and molding apparatus by which the moldings having the microscopic structure of high aspect ratio can be molded more simply and at low cost, can be offered.

Although the present invention has been fully described by way of examples with reference to the accompanying drawings, it is to be noted that the various changes and modifications will be apparent to those skilled in the art. Therefore, unless such changes and modifications depart from the scope of the present invention, they should be construed as being included therein.

What is claimed is:

1. A molding method comprising the steps of:
attaching a raw material whose elastic modulus is 1-4 (GPa) to a holding unit;
setting a temperature of a mold having a microscopic structure to a temperature higher than a glass transition point temperature of the raw material; and
pressing the mold toward the raw material so as to transfer the microscopic structure onto the raw material.

2. The molding method of claim 1, further comprising the step of:
releasing the mold from the raw material under a condition that the raw material is heated.

3. The molding method of claim 2, wherein the heating of the raw material in the step for releasing the mold is carried out in such a manner that a rear surface of the raw material is heated.

4. The molding method of claim 1, further comprising the step:
releasing the mold from the raw material while a tensile stress is being given to the raw material.

5. The molding method of claim 1, further comprising the step:
releasing the mold from the raw material while a tensile stress is being given to the raw material, under a condition that the raw material is heated.

6. The molding method of claim 1, wherein the raw material is a raw material of an optical element.

7. The molding method of claim 1, wherein the microscopic structure has an aspect ratio larger than 1, and includes a plurality of line-and-spaces arranged in a predetermined pitch.

8. A molding method comprising the steps of:
attaching a raw material to a holding unit;
setting a temperature of a mold having a microscopic structure to a temperature higher than a glass transition point temperature of the raw material;
pressing the mold toward the raw material so as to transfer the microscopic structure onto the raw material; and
releasing the mold from the raw material under a condition that the raw material is heated.

9. The molding method of claim 8, wherein an elastic modulus of the raw material at a normal temperature is 1-4 (GPa).

10. The molding method of claim 8, wherein a heating of the raw material in the step for releasing the mold is carried out in such a manner that a rear surface of the raw material is heated.

11. The molding method of claim 8, wherein the raw material is a raw material of an optical element.

12. The molding method of claim 8, wherein the microscopic structure has an aspect ratio larger than 1, and includes a plurality of line-and-spaces arranged in a predetermined pitch.

13. A molding method comprising the steps of:
attaching a raw material to a holding unit;
setting a temperature of a mold having a microscopic structure to a temperature higher than a glass transition point temperature of the raw material;
pressing the mold toward the raw material so as to transfer the microscopic structure onto the raw material; and
releasing the mold from the raw material while a tensile stress is being given to the raw material.

14. The molding method of claim 13, wherein the raw material is a raw material of an optical element.

15. The molding method of claim 13, wherein the microscopic structure has an aspect ratio larger than 1, and includes a plurality of line-and-spaces arranged in a predetermined pitch.

16. A molding apparatus comprising:
a mold having a microscopic structure;
a holding unit for holding a raw material;
a first heater for heating the mold;
a second heater for heating the holding unit;
a driving unit for relatively moving the mold and the holding unit; and
a control unit for controlling the first heater, the second heater and the driving unit so that the mold is released from the raw material, under a condition that a rear surface of the raw material is heated by the second heater, after the mold heated by the first heater is pressed toward the raw material and the microscopic structure is transferred onto the raw material.

17. The molding apparatus of claim 16, wherein an elastic modulus of the raw material at a normal temperature is 1-4 (GPa).

18. The molding apparatus of claim 16, wherein the raw material is a raw material of an optical element.

19. The molding apparatus of claim 16, wherein the microscopic structure has an aspect ratio larger than 1, and includes a plurality of line-and-spaces arranged in a predetermined pitch.
